(19) United States
(12) Patent Application Publication
(10) Pub. No.: US 2008/0278664 A1
(43) Pub. Date: Nov. 13, 2008

(54) MICRO-LENS SUBSTRATE WITH COLOR FILTER, ELECTRO-OPTICAL DEVICE, ELECTRONIC APPARATUS, AND METHOD OF MANUFACTURING MICRO-LENS SUBSTRATE WITH COLOR FILTER

(75) Inventor: Kosei OKAYAMA, Fujimi-machi (JP)

Correspondence Address: LOWE HAUPTMAN HAM & BERNER, LLP, 1700 DIAGONAL ROAD, SUITE 300, ALEXANDRIA, VA, 22314, US

(73) Assignee: SEIKO EPSON CORPORATION, Tokyo (JP)

(21) Appl. No.: 12/115,242

(22) Filed: May 5, 2008

(30) Foreign Application Priority Data
May 9, 2007 (JP) 2007-124210

(51) Int. Cl. G02F 1/1335; G02F 1/13

(52) U.S. Cl. 349/95; 349/108; 349/187

(57) ABSTRACT

A micro-lens substrate with a color filter includes a first transparent substrate having a surface with first concave portions which have a lens shape, color filters in a plurality of colors, the color filters having a refractive index different from that of the first transparent substrate, the color filters being filled in the first concave portions, a transparent protective layer over the color filters, the transparent protective layer having a second concave portion at an area overlapping a border adjacent ones of the first concave portions, and a light shielding layer formed in the second concave portion.

### BACKGROUND

1. Technical Field

The present invention relates to a micro-lens substrate with a color filter is attached, an elect-optical device including the micro-lens substrate with the color filter, an electronic apparatus including the electro-optical device, and a method of manufacturing the micro-lens with the color filter.

2. Related Art

Among various kinds of electro-optical devices, a liquid crystal device (LCD) generally consists of an element substrate on which pixel transistors and pixel electrodes are formed, an opposing substrate arranged to face the element substrate, and liquid crystals held between the element substrate and the opposing substrate. Besides the pixel transistors, the element substrate is provided with various wirings. Since the domains in which the pixel transistors and wirings are formed are not transparent, these domains do not contribute to a display directly. Moreover, if a large amount of light is incident onto the pixel transistors, the off-leak current will occur, resulting in deterioration of contrast. For such a reason, JP-A-2001-39737 discloses a liquid crystal device in which a micro-lens substrate with a plurality of micro-lenses at positions corresponding to the pixel electrodes is used as an opposing substrate. This micro-lens substrate can lead the light, which is entered from the opposing substrate side, to the pixel electrodes with high efficiency.

On the other hand, when displaying a color picture with the liquid crystal device, if the liquid crystal device is a projected type display, three sheets of liquid crystal devices are respectively used as light valves corresponding to respective colors, light components optically modulated by the respective liquid crystal devices are synthesized, and the synthesized light is projected. Moreover, the liquid crystal device is provided with a color filter on the opposing substrate side, and each pixel serves as a sub-pixel corresponding to a color.

In order to perform a color display in a liquid crystal display device, three sheets of liquid crystal devices or color filters will be used, but the structure employing the color filters can attain the advantage of simplification. If the micro-lenses are used, it is possible to improve the light-use efficiency. For such a reason, the inventor of the present invention suggests a liquid crystal device for a color display with high light-use efficiency here by forming both the micro-lenses and the color filters in a common substrate because the conventional liquid crystal display is disadvantages in that it is impossible to attain the cost merit by adding the color filters to the conventional micro-lens substrate, and it is impossible to display a high definition picture when the relative accuracy of positions of the micro-lenses and the color filters is low. Moreover, if the color filters are arranged to be very close to each other in the case in which the color filters are formed on the substrate, the light which has advanced on the slant will invade into adjacent pixels, and, thereby, the problem of interference of mixed colors or light will occur.

### SUMMARY

An advantage of the aspects of the invention is that it provides a micro-lens substrate with a color filter in which a micro-lens and a color filter are formed with high accuracy in position on the same substrate at low cost, and which can solve problems, such as mixed colors. It further provides an electro-optical device having the micro-lens substrate with a color filter, an electronic apparatus including the electro-optical device, and a method of manufacturing the micro-lens substrate with the color filter.

According to one aspect of the invention, there is provided with a micro-lens substrate with a color filter including a first transparent substrate having a surface on which a plurality of first concave portions which have a lens shape and are filled with color filter material of a plurality of colors, the color filter material having a refractive index different from that of the first transparent substrate, a transparent protective layer which is formed on the surface of the first transparent substrate, the surface having the color filter material thereon, and which has second concave portions on the surface thereof at domains overlapping the boundaries of the adjacent corresponding first concave portions, and a light shielding layer formed in the second concave portions.

In the micro-lens substrate with a color filter according to this aspect, since the first concave portions having a lens shape are filled with the color filter material formed on the surface of the first transparent substrate, the micro-lens itself functions as a color filter. For this reason, even when adding the color filters to the micro-lens substrate, there is almost no increase of cost. Moreover, since the relative accuracy of positions of the micro-lens and the color filter does not cause any problem because the micro-lens itself functions as the color filter. For such a reason, it is possible to display a brighter and higher definition color picture. Moreover, since the light shielding layer is formed at an area overlapping the boundary area of the adjacent first concave portions, it is possible to prevent light from entering an unnecessary portion and mixed colors from occurring. Moreover, since the second concave portion is formed at the boundary area of the adjacent first concave portion in the surface of the transparent protective layer which covers the color filter material, and the light shielding layer is formed in the second concave portion, the color filter material and the light shielding layer are close to each other by the depth of the second concave portion. For this reason, since the light which has advanced on the slant does not invade into the adjacent pixels even when color filters are close to each other, it is possible to avoid the mixed colors or interference of light, are certainly avoidable from occurring.

In the micro-lens substrate, the transparent protective layer is a second transparent substrate bonded to the first transparent substrate so as to cover the color filter material.

In the micro-lens substrate, the color filter material has a refractive index higher than that of the first transparent substrate.

The micro-lens substrate with a color filter according to this aspect is used in an electro-optical device. In this case, when the electro-optical device is a liquid crystal device among various kinds of electro-optical devices, liquid crystals are held between the micro-lens substrate with a color filter and an opposing substrate facing the micro-lens substrate.

According to another aspect of the invention, there is provided a method of manufacturing a micro-lens substrate with a color filter including forming a base material by forming a first transparent substrate having a surface on which a plurality of first concave portions, each having a lens shape, filling the plurality of first concave portions with a plurality of colors of color filter material, which has a refractive index different from that of the first transparent substrate, forming a transparent protective layer to cover the surface of the first transparent substrate, the surface having the color filter material thereon, forming a second concave portion on a surface of the transparent protective layer at an area overlapping a border of the first concave portion which is adjacent to the second concave portion, and forming a light shielding layer in the second concave portion.

In the method, it is preferable that the filling the plurality of first concave portions is performed by ejecting the color filter material into the plurality of first concave portions from a liquid ejection head to fill the first concave portions. With such a method, it is easy and efficient to selectively fill the plurality of concave portions with respective predetermined colors of color filter material.

In the method, it is preferable that the forming a light shielding layer is performed by bonding a second transparent substrate to the first transparent substrate so as to cover the color filter material, and forming the transparent protective layer by the second transparent substrate.

According to a further aspect of the invention there is provided an electronic apparatus including the electro-optical device. The electronic apparatus may be a direct-view type color display device and a projection-type display device.

### BRIEF DESCRIPTION OF THE DRAWINGS

The invention will be described with reference to the accompanying drawings, wherein like numbers reference like elements.

FIG. 1A is a plan view illustrating an electro-optical device to which the invention is applied and respective elements of the electro-optical device, the plan view viewed from the opposing substrate side, and FIG. 1B is a sectional view taken along line IB-IB in FIG. 1A.

FIG. 2 is an equivalent circuit diagram illustrating electrical connection of an image display area of the electro-optical device to which the invention is applied.

FIG. 3 is a plan view illustrating pixels adjacent to each other in an element substrate of the electro-optical device to which the invention is applied.

FIGS. 4A, 4B, and 4C are sectional views taken along line IV-IV in the electro-optical device shown in FIG. 3, in which FIG. 4B is a sectional view illustrating a micro-lens substrate with a color filter applied to the electro-optical device of the invention, and FIG. 4C is a sectional view illustrating a micro-lens substrate with a color filter according to a related art.

FIGS. 5A to 5K are sectional views illustrating processing flow of a method of manufacturing a micro-lens substrate with a color filter according to the invention.

FIG. 6A is a schematic view illustrating an inside structure of a liquid ejection head used in a liquid ejection device, FIG. 6B is an explanatory view for explaining a pressure generation element in a deflection vibration mode, and FIG. 6C is an explanatory view illustrating a pressure generation element in a longitudinal vibration mode.

FIGS. 7A and 7B are explanatory views illustrating electronic apparatuses employing the electro-optical device to which the invention is applied.

### DESCRIPTION OF EXEMPLARY EMBODIMENTS

The form of implementation of this invention is explained hereafter. In order to make each class and each part material into the size of the grade which can be recognized on a drawing, scales are made to have differed for each class or every each part material in the figure referred to by the following explanation.

### Overall Structure

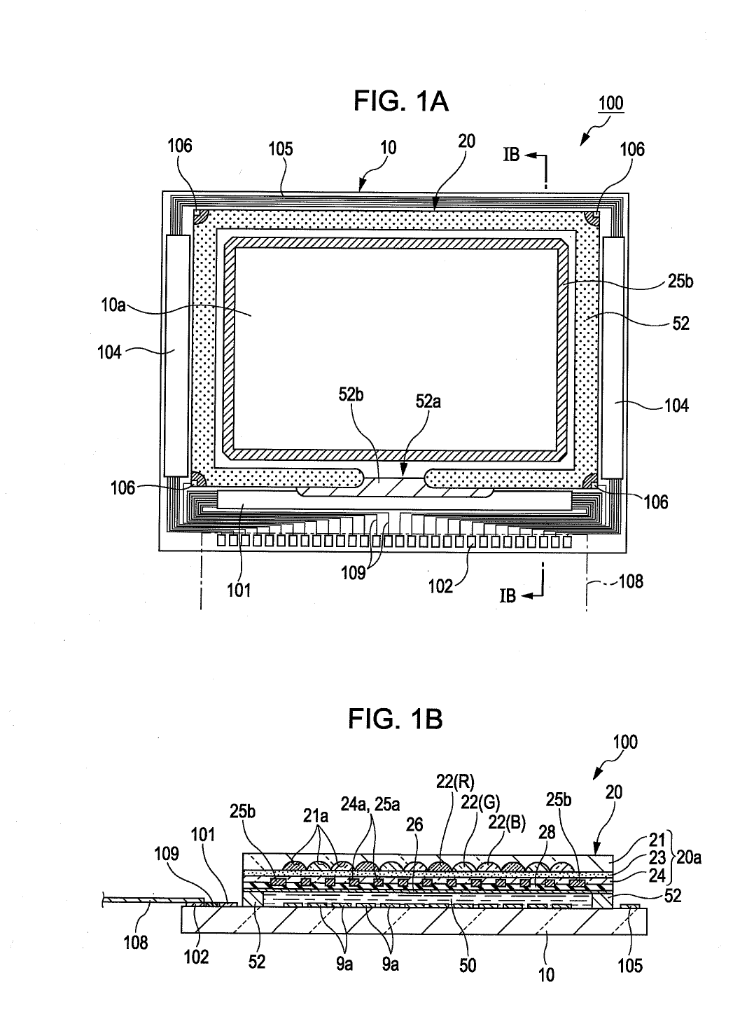

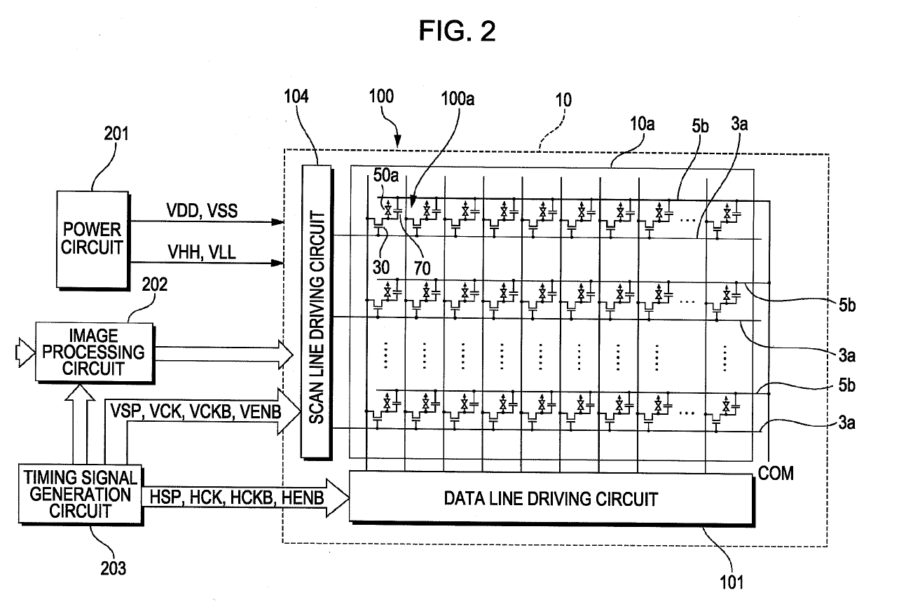

FIG. 1A is a plan view illustrating an electro-optical device to which the invention is applied and various elements thereof, the view being viewed from an opposing substrate side, and FIG. 1B is a sectional view taken along line IB-IB of FIG. 1A. FIG. 2 is an equivalent circuit diagram illustrating electrical structure of an image display area of the electro-optical device to which the invention is applied.

The electro-optical device 100 shown in FIGS. 1A and 1B includes an element substrate 10 and an opposing substrate 20 facing the element substrate 10, and is a transmissive liquid crystal device which modulates light entering from the opposing substrate side and emits the light via the element substrate. The element substrate 10 and the opposing substrate 20 which face each other and are bonded to each other with a sealing member 52 therebetween. In an area inside the sealing member 52, a liquid crystal layer 50 consisting of twisted nematic (TN) liquid crystals is disposed. The sealing member 52 is provided with a liquid crystal injection hole 52a and is sealed with a sealing agent 52b after the liquid crystals are injected through the liquid crystal injection hole 52a. In the inside area of the sealing member 52 on the opposing substrate 20, a light shielding layer 25b is also provided like a frame in parallel to the sealing member 52 and the inner side area of the light shielding layer 25b is used as an image display area 10a.

At an outside area of the sealing member 52 in the element substrate 10, a data line drive circuit 101 and mounting pads 102 are formed along with one side of the element substrate 10, scan line driving circuits 104 are formed along two sides of the element substrate 10, which are adjacent to the side along which the data line driving circuit 10 and the mounting pads 102 are arranged. A plurality of wirings 109 extends from the mounting pads 102 to the data line driving circuit 101 and the scan line driving circuits 104. Further, a flexible substrate on which an IC 107 is mounted is connected to the element substrate 10 using the mounting pad 102. A plurality of wirings 105 for connection between the scan line driving circuits arranged at both opposing sides of the image display area 10a is arranged along the remaining one side of the element substrate 10. Up-and-down electrical interconnection members 106 are provided at four corners of the opposing substrate 20 for electrical connection between the element substrate 10 and the opposing substrate 20.

On the element substrate 10, a plurality of transparent pixel electrodes 9a made of an Indium Tin Oxide (ITO) film is formed in a matrix form in the image display area 10a. On the other hand, a common electrode 26 which is transparent and made of an ITO film is formed on the opposing substrate (on the liquid crystal layer 50 side) so as to cover almost all the entire surface of the opposing substrate 20. Moreover, a micro-lens substrate 20a with a color filter is used for the opposing substrate 20, which will be described later in detail. In addition, FIG. 1B shows the section of the electro-optical device in the case in which color filters are arranged in a mosaic form. Alternatively, the color filters may be arranged by predetermined patterns, such as stripe arrangement or triangle arrangement.

As shown in FIG. 2, in the element substrate 10 of the electro-optical device 100, each of a plurality of pixels 100a which forms the image display area 10a and are arranged in a matrix form includes a pixel electrode 9a and a metal oxide semiconductor field effect transistor (MOSFET) 30 which serves as a pixel transistor which controls switching of the pixel electrode 9a. Moreover, the image display area 10a is provided with a plurality of data lines 6a which supplies image signals, and a plurality of scan lines 3a which supplies scan signals. The data lines 6a and the scan lines 3a extend to intersect another. The data lines 6a are connected to the data line driving circuit 101, and the scan lines 3a are connected to the scan line driving circuit 104. A source of the MOSFET 30 is connected with the data line 6a and a gate of the MOSFET 30 is connected with the scan line 3a. The pixel electrode 9a is connected with a drain of the MOSFET 30, and writes in the data signal supplied from the data line 6a into the corresponding pixel 100a at a predetermined timing by turning on the MOSFET 30 and maintaining the turn-on state of the MOSFET 30 during a predetermined period. The pixel signal of a predetermined level written in the liquid crystal capacitor 50a consisting of the pixel electrode 9a, the liquid crystal layer 50, and the common electrode 26 shown in FIG. 1B is maintained during a fixed period.

Here, storage capacitors 70 are formed in parallel with the liquid crystal capacitors 50a. By the presence of the storage capacitor 70, the voltage of the pixel electrode 9a is maintained for a period three-digit time longer than a period during which the sauce voltage is applied. Thereby, the charge holding characteristic improves and it is possible to realize the electro-optical device 100 which can perform a display having a high contrast ratio. With this embodiment, in order to constitute the storage capacitors 70, the capacitor lines 5b are formed to be in parallel to the scan lines 3a. The capacitor lines 5b are connected with a common potential line (COM), and are held at predetermined potential. In addition, the storage capacitors 70 may be formed between the capacitor lines 5b and the previous scan lines 3a.

In addition, the electro-optical device 100 is equipped with a power supply circuit 201, an image-processing circuit 202, and a timing signal generation circuit 203. These circuits input a signal into the element substrate 10 via the flexible substrate 108 shown in FIGS. 1A and 1B. In the timing signal generation circuit 203, a dot clock for driving each pixel 100a is generated, and clock signals VCK and HCK, complementary clock signals VCKB and HCKB, and transmission start pulses HSP and VSP are generated on the basis of the dot clock and supplied to the element substrate 10. When input image data is inputted from the outside, the image-processing circuit 202 will generate an image signal on the basis of the input image data, and will supply it to the element substrate 10. The power supply circuit 201 generates a plurality of powers VDD, VSS, VHH, and VLL, and supplies them to the element substrate 10.

### Concrete Structure of Element Substrate

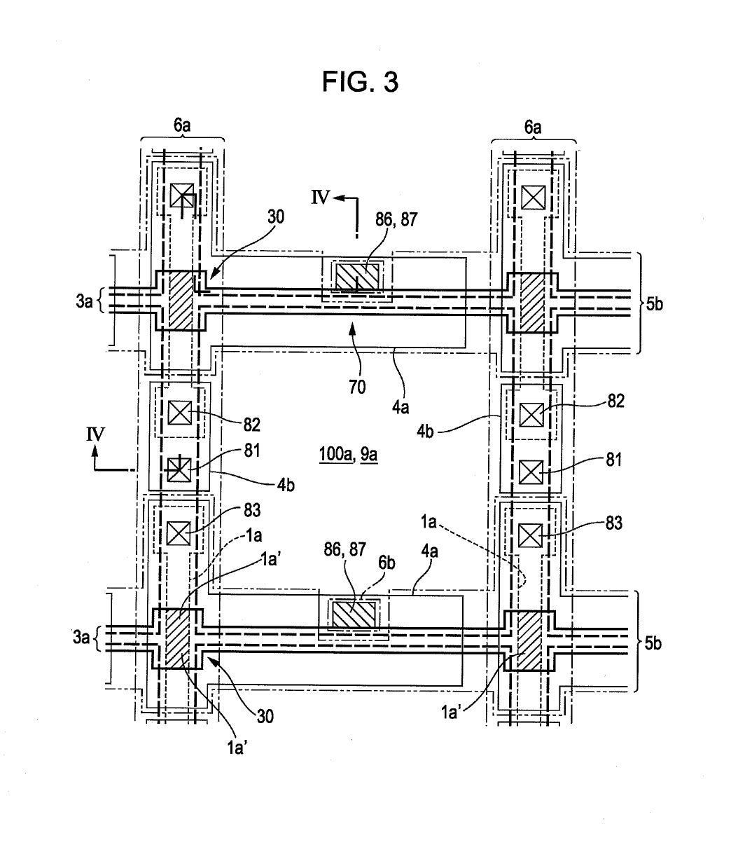

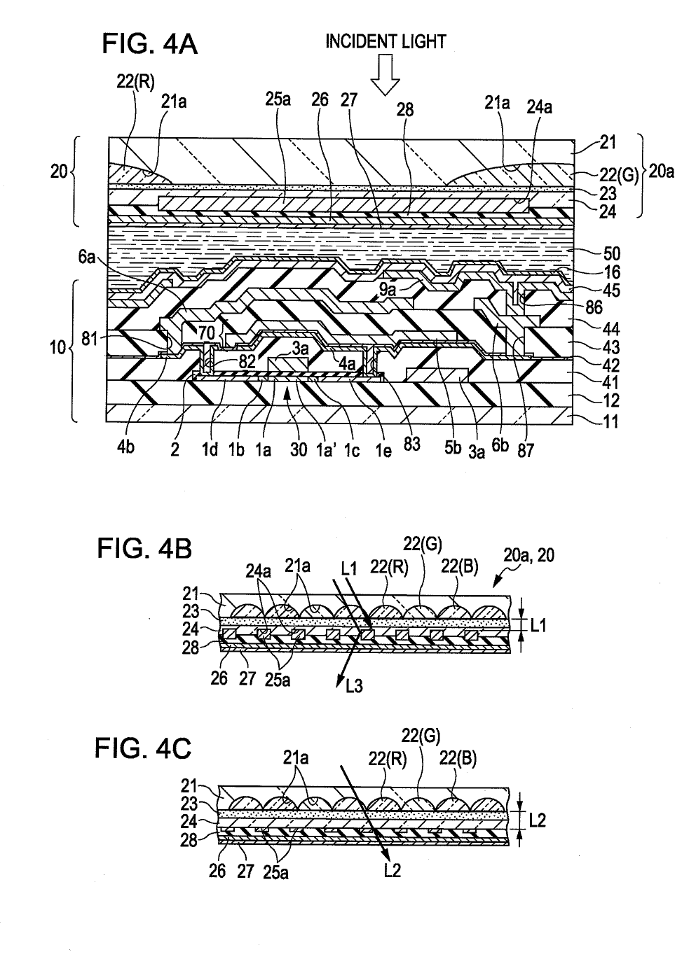

FIG. 3 is a plan view illustrating pixels adjacent to each other in the element substrate of the electro-optical device to which the invention is applied. FIGS. 4A, 4B, and 4C are sectional views taken along line IV-IV of FIG. 3. FIG. 4A shows the electro-optical device to which the invention is applied, FIG. 4B shows the micro-lens substrate with a color filter used in the electro-optical device to which the invention is applied, and FIG. 4C shows a micro-lens substrate with a color filter according to a related art. In FIG. 3, a dotted line indicates a semiconductor layer, a thick solid line indicates the scan lines 3a, an one-point chain line indicates the data lines 6a and a thin film which is simultaneously formed with the data line 6a, a two-point chain line indicates the capacitor lines 5b, a thick and long dashed line indicates the pixel electrodes 9a and a thin film which is simultaneously formed with the pixel electrodes 9a, and a thin solid line indicates a relay electrode which will be mentioned later.

As shown in FIG. 3, on the element substrate 10, a rectangular pixel electrode 9a is formed in each of the pixels 100a, and the data lines 6a and the scan lines 3a are formed extending along the boundary of each pixel electrode 9a in longitudinal direction and lateral direction, respectively. The data lines 6a and the scan lines 3a extend linearly, and the electric field effect transistor (FET) 30 is formed in each domain at which each data line 6a and each scan line 3a intersect another. Moreover, in the element substrate 10, the capacitor lines 5b are formed so as to overlap with the scan lines 3a, and each of the capacitor line 5b includes a main-line portion linearly extending so as to overlap with the corresponding scan line 3a, and a sub-line portion extending so as to overlap with the corresponding data line 6a at an intersection of the corresponding data line 6a and the corresponding scan line 3a.

As shown in FIG. 4A, the element substrate 10 consists of a support substrate 11 (based plate) made of transparent materials, such as a quartz substrate and a glass substrate, pixel electrodes 9a formed on the surface of the base substrate, the surface having a liquid crystal layer 50 thereon, electric field effect transistors (FETs) 30 serving as pixel switching elements, and an aligning film 16.

In the element substrate 10, the electric field effect transistors 30 are formed in the positions adjacent to the pixel electrodes 9a. For example, each electric field effect transistor 30 has a so-called Lightly Doped Drain (LDD) structure, and thus a semiconductor layer 1a has a channel region 1a′ facing the scan line 3a with a gate insulation layer 2 therebetween, a lightly-doped source region 1b, a lightly-doped drain region 1c, a highly-doped source region 1d, and a lightly-doped drain region 1e therein.

For example, the semiconductor layer 1a is made of a single-crystal silicon layer. The semiconductor 1a is formed on the support substrate 11 made of a quartz substrate with a base insulation layer 12 therebetween. The element substrate 10 having such a structure can be realized by a silicon-on-insulator (SOI) substrate formed by bonding a quartz substrate to a single-crystal silicon substrate with an insulation therebetweeen. The SOI substrate may be made through a method of forming a silicon oxide film on a single-crystal silicon substrate and then bonding the single-crystal silicon substrate with the silicon oxide layer to a quartz substrate, or through a method of forming silicon oxide films on a quartz substrate and a silicon-crystal silicon substrate, respectively, and then bringing the silicon oxide films into contact with each other to bond the quartz substrate to the single-crystal silicon substrate. In the case of using such a substrate, a gate insulation layer 2 is formed of a thermal oxide film by performing a thermal oxidation process with respect to the semiconductor layer 1a. The scan lines 3a are made of polysilicon, amorphous silicon, a silicon film such as a single-crystal silicon film, polycide of these silicon films, silicide, and a metal film.

A first interlayer insulation film 41 that is made of a silicone oxide film and has a contact hole 82 which leads to the highly-doped source region 1d and a contact hole 83 which leads to the highly-doped drain region 1e is formed on the scan lines 3a. Relay electrodes 4a and 4b are formed in an upper layer of the first interlayer insulation film 41. The relay electrode 4a is formed in almost L shape so as to extend along the scan line 3a and the data line 6a, in which a crossing position of the scan line 3a and the data line 6a serves a center position of the L shape. The relay electrode 4b is formed to extend along the data line 6a at a position spaced apart from the relay electrode 4a. The relay electrode 4a is electrically connected to the highly-doped drain region 1e via the contact hole 83, and the relay electrode 4b is electrically connected to the highly-doped source region 1d via the contact hole 82.

A dielectric film 42 made of a silicone nitride film is formed in an upper layer of the relay electrodes 4a and 4b. A capacitor line 5b is formed in an upper layer of the dielectric film 42 so as to face the relay electrode 4a, and a storage capacitor 70 is formed in it. The relay electrodes 4a and 4b are made of a conductive polysilicon film or a conductive metal film. The capacitor line 5b is made of a conductive polysilicon film, a metal silicide film containing a refractory metal, a lamination layer consisting of these films, or a metal film.

A second interlayer insulation film 43 that is made of a silicone oxide film and has a contact hole 87 which leads to the relay electrode 4a, and a contact hole 81 which leads to the relay electrode 4b is formed in an upper layer of the capacitor lines 5b. The data line 6a and a drain electrode 6b are formed in an upper layer of the second interlayer insulation film 43. The data line 6a is electrically connected to the relay electrode 4b via the contact hole 81 and to the highly-doped source region 1d via the relay electrode 4b. The drain electrode 6b is electrically connected to the relay electrode 4a via the contact hole 87 and to the highly-doped drain region 1e via the relay electrode 4a. The data line 6a and the drain electrode 6b are made of a conductive polysilicon film, a metal silicide film containing a refractory metal, or a lamination layer of these films.

A third interlayer insulation film 44 that is made of a silicone oxide film and has a contact hole 86 which leads to the drain electrode 6b is formed in an upper layer of the data line 6a and the drain electrode 6b. A pixel electrode 9a is formed in an upper layer of the third interlayer insulation film 44, and the pixel electrode 9a is electrically connected to the drain electrode 6b via the contact hole 86. An aligning film 16 is formed in an upper layer of the pixel electrode 9a.

Therefore, with the electro-optical device 100 of this embodiment, a first wiring region in which the scan line 3a and the capacitor line 5b are formed, a second wiring region in which the data line 6a extends in the direction which crosses to the first wiring region, and a formation region of the electric field effect transistor 30 constitute a non-display region having a lattice shape which does not directly contribute to a display, and the domain surrounded by this non-display region serves as a pixel open region which directly contributes to a display.

### Concrete Structure of Opposing Substrate

As described below, in FIGS. 1B, 4A, and 4B, a micro-lens substrate 20a with micro-lenses and color filters 22(R), 22(G), and 22(B) is used as the opposing substrate 20.

In the opposing substrate 20, first concave portions 21a, each having a lens shape, are formed on the surface of a first transparent substrate 21, and the first concave portions 21a are filled with a transparent material having a different refractive index from that of the first transparent substrate 21. Here, in each of the first concave portions 21a, the color filter material (transparent colored material) of a plurality of colors which has coloring nature of different colors (red (R), green (G), blue (B)) is filled up with as a transparent material and solidified to be lens-shaped color filters 22 (R), 22(G), and 22(B). Moreover, since the first concave portions 21a and the color filters 22 (R), 22(G), and 22(B) are formed in a concave lens form which they are viewed from the incidence side of light (light source side), with this embodiment, the material whose refractive index is higher than the first transparent substrate 21 is used as the transparent material (color filter material). For this reason, the color filters 22 (R), 22(G), and 22(B) function as micro-lenses, and converge the light entering from the opposing substrate 20 side to each pixel electrode 9a. In this embodiment, each of the first concave portions 21a and the color filter 22(R), 22(G), and 22(B) has about a circular shape and a circular plane form.

With this embodiment, a second transparent substrate 24 (a cover glass/a transparent protective layer) is joined to the surface (the surface facing the element substrate 10) of the first transparent substrate 21 by an adhesives layer 23 so that the color filters 22 (R), 22(G), and 22(B) may be covered.

Moreover, in this embodiment, a light shielding layer 25a called black matrix is formed in the second transparent substrate 24 along the boundary region of the first concave portion 21a. Therefore, the light shielding layer 25a will be formed along the boundary region of the pixel electrode 9a of the element substrate 10. Here, the light shielding layer 25a is made of a light shielding film, such as molybdenum (Mo), tungsten (W), titanium (Ti), titanium nitride (TiN), and chromium (Cr), which is simultaneously formed with the light shielding layer 25b constituting a frame.

In constituting such a light shielding layer 25a, with this embodiment slot-like second concave portions 24a are formed on the surface (the surface facing the element substrate 10) of the second transparent substrate 24 along the boundaries of the first concave portions 21a, and the light shielding layer 25a is formed so as to fill the inside of such second concave portions 24a.

For this reason, as compared with the case in which the light shielding layer 25a is directly formed on the second transparent substrate 24 without forming the second concave portion 24a, as shown in FIG. 4C, the light shielding layer 25a and the color filters 22(R), 22(G), and 22(B) are close to the surface of the second transparent substrate 24 with this embodiment. With this embodiment shown in FIG. 4B, the distance L1 between the light shielding layer 25a and each of the color filters 22(R), 22(G), and 22(B) is the sum of the thickness of the adhesives layer 23 and the thickness of the second transparent substrate 24, the thickness from the bottom of each of the second concave portions 24a. Accordingly, in the related art shown in FIG. 4C, the distance L2 between the light-shielding layer 25a and each of the color filters 22(R), 22(G), and 22(B) is the sum of the thickness of the adhesive layer 23 and the thickness of the second transparent substrate 24.

Here, since the thickness of the light shielding layer 25a is larger than the depth of each of the second concave portions 24a, a portion of the light shielding layer 25a overflows the second concave portion 24a. However, since a transparent insulation film 28 is formed on the surface of the second transparent substrate 24 over the entire surface, the unevenness resulting from the light shielding layer 25a is removed by the insulated film 28.

On the insulation film 28, a common electrode 26 made of an ITO film is formed on the surface (the surface facing the element substrate 10) of the second transparent substrate 24. Moreover an aligning film 27 is formed in an upper layer of the insulation film 28. Thus, with this embodiment, the first transparent substrate 21, the color filters 22(R), 22(G), and 22(B), the adhesives layer 23, the second transparent substrate 24, and the light shielding layer 25a constitute the micro-lens substrate 20a with a color filter, and the opposing substrate 20 is constituted using the micro-lens substrate 20a with a color filter.

Method of Manufacturing a Micro-Lens Substrate with a Color Filter

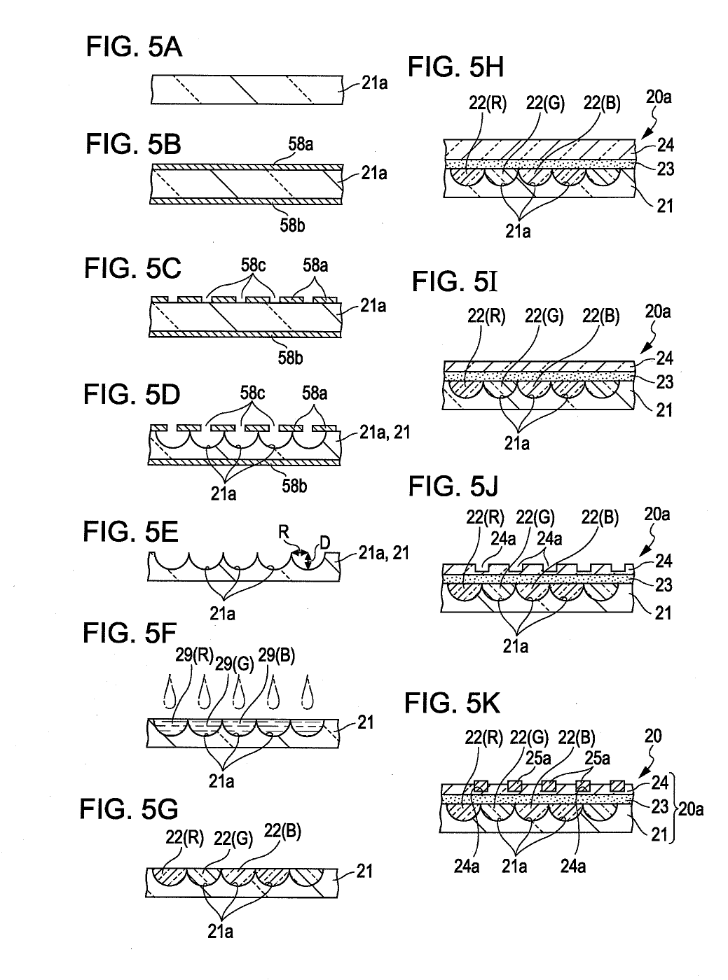

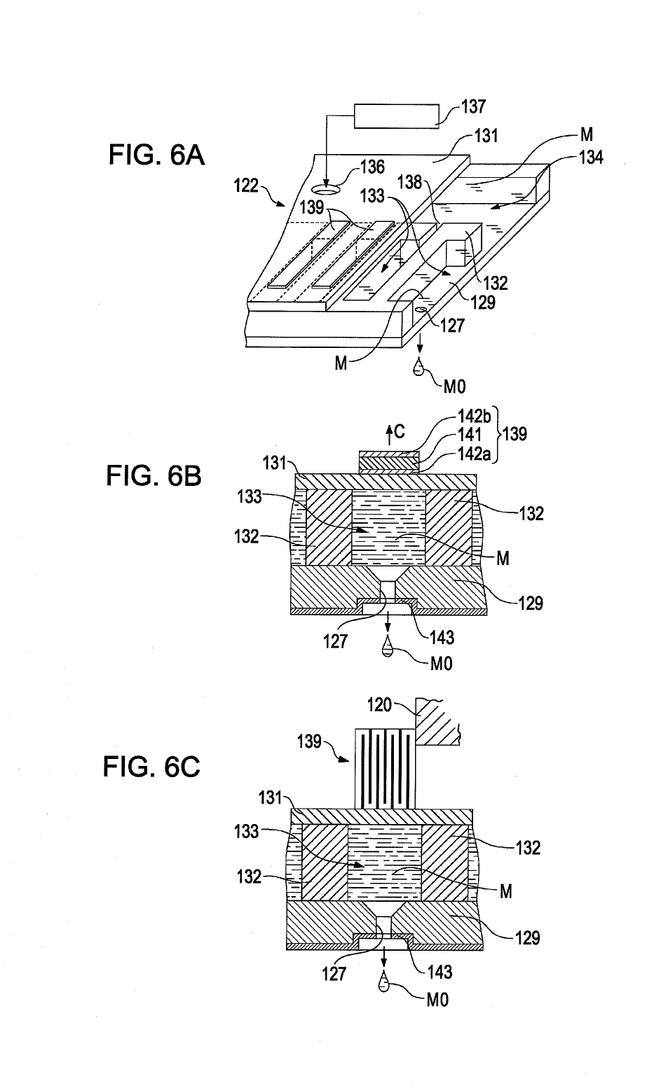

A method of manufacturing a micro-lens substrate 20a with a color filter, and the structure of the micro-lens substrate 20a with a color filer will be described with reference to FIGS. 5A through 5K, and FIG. 6. FIGS. 5A through 5K are sectional views illustrating a method of manufacturing a micro-lens substrate with a color filter which is used in an electro-optical device to which the invention is applied. FIGS. 6A, 6B, and 6C are explanatory views schematically illustrating the inside structure of a liquid ejection head used in a liquid ejection device, a pressure generation element in a deflection vibration mode, and a pressure generation element in a longitudinal vibration mode, respectively.

In order to manufacture the micro-lens substrate 20a with a color filter of this embodiment, a first transparent substrate 21 which is transparent and has a plurality of first concave portions 21 having a lens shape on the surface thereof is formed as a base material forming process.

As shown in FIG. 5A, a glass substrate 21d is prepared first. The thickness of the glass substrates 21d is about 0.3 to 3 mm, and more preferably about 0.2 to 2 mm. Here, in the case in which the glass substrate 21d is not processed, the glass substrate 21d does not have sufficient smoothness but has fine unevenness or cracks on the surface thereof. Accordingly, the surface of the glass substrate 21d must be ground. Such grinding is performed using abrasives (grains), such as cerium oxide and colloidal silica. As a result of the grinding, when an affected layer is formed on the surface of the glass substrate 21d, the glass substrate 21d undergoes a wet etching, a dry etching, a reverse sputtering, or a chemical mechanical polishing (CMP) so that a surface portion of the grass substrate 21d, the surface portion having the depth of 0.1 μm, is removed and thus the affected layer is removed. The affected layer is a layer which comes to have different properties or characteristics from an inner portion of the glass substrate 21d due to change of a crystal state, phase transformation, and remaining stress attributable to the heat and stress applied to the surface of the glass substrate 21d during the processing, such as polishing.

Next, as shown in FIG. 5B, mask layers 58a and 58b are formed on the front surface or the back surface of the glass substrate 21d by a gaseous phase film-forming method, such as chemical vapor deposition method (CVD), a sputtering method, and a vapor-deposition method, or a plating method. These mask layers 58a and 58b may be made of Au/Cr, Au/Ti, Pt/Cr, Pt/Ti, silicone (polycrystalline silicon, amorphous silicon), a silicon nitride film. If the affected layer is removed before such mask layers 58a and 58b are formed, it is possible to obtain relatively high adhesion between the glass substrate 21d and the mask layers 58a and 58b, leading to the decreased side-etching in an etching process performed with respect to the glass substrate 21d. Moreover, the mask layers 58a and 58b are made of silicon, it is possible to obtain more dense mask layers 58a and 58b to improve the adhesion of the glass substrate 21d.

Next, as shown in FIG. 5C, a plurality of openings 58c is formed in the mask layer 58a formed on the surface of the glass substrate 21d. Referring to FIGS. 4A and 4B, the openings 58c are formed at positions at which the first concave portions 21a are formed and have a circular shape. That is, the shape of the openings 58c corresponds to the shape of the first concave portions 21a. The openings 58c may be formed through a method including a process of forming a resist mask (not shown) on the mask layers 58a and 58b by a photolithography technique, and an etching process of etching the mask layers 58a and 58b through openings of the resist mask by a dry etching using CF gas or chlorine-based gas or a wet etching using an aqueous solution of fluoric acid+nitric acid, alkaline aqueous solution, etc.

Next, as shown in FIG. 5D, an etching is performed with respect to the glass substrate 21d through the openings 58c of the mask layers 58a and 58b to form the plurality of first concave portions 21a, which is lens-shaped, on the glass substrate 21d. The etching may be a wet etching method using the solution (etching solution) containing polyhydric alcohol and fluoric acid, such as glycerin and ethylene glycol, or a dry etching method. With the wet etching method, it is possible to form the first concave portions 21a having an almost ideal lens shape.

Next, as shown in FIG. 5E, the first transparent substrate 21 that has the plurality of first concave portions 21a having a lens form on the surface thereof by removing the mask layers 58a and 58b by a wet etching method using chloride+nitric acid solution, or alkaline aqueous solution (for example, tetramethyl ammonium hydroxide aqueous solution), or fluoric acid+nitric acid solution, or a dry etching method using CF gas, chlorine-based gas, etc. Here, when the maximum depth (average) of the first concave portion 21a is set to D and the opening radius (average) is set to R, it is preferable that R/D is about 0.8 to 2.0, and it is more preferable that R/D is about 0.9 to 1.5. If the first concave portions 21a are formed so that R/D may become within such range, it is possible to form the first concave portions 21a having a more ideal lens form.

Next, in a color filter material filling process, as shown in FIG. 5F, each of the plurality of first concave portions 21a is filled up with the transparent material which has a different refractive index from the first transparent substrate 21. As the transparent material, color filter materials 29(R), 29(G), and 29(B) which are prepared by dissolving and dispersing a certain kind of resin (for example, epoxy-based resin, acryl-based resin, or a precursor thereof) having a higher refractive index then the glass substrate 21d into a predetermined solvent to obtain a solution, and then blending dyes or pigments of colors (red (R), green (G), blue (B)) with the solution. The first concave portion 21a corresponding to a red (R) pixel is filled up with the red (R) color filter material 29(R). The first concave portion 21a corresponding to a green (G) pixel is filled up with the green (G) color filter material 29(G), and the first concave portion 21a corresponding to a blue (B) pixel is filled up with the blue (B) color filter material 29(B). In addition, the color filter materials 29(R), 29(G), and 29(B) are not limited to colored materials containing dyes or pigments, but may be just transparent materials which have wavelength selective transparency.

In performing such a filling process, with this embodiment, the respective color filter materials 29(R), 29(G), and 29(B) are ejected from a liquid ejection head 122 shown in FIG. 6A to fill up the corresponding first concave portions 21a. In greater detail, the liquid ejection head 122 is connected with a liquid storage section 137 having a tank form or a cartridge form, which stores a liquid-phase material M (for example, color filter material 29(R)) which is discharged as liquid drops, and is equipped with nozzle rows, in which a plurality of nozzle orifices 127 is arranged in rows, on the undersurface thereof. Moreover, as shown in FIGS. 6A and 6B, the liquid ejection head 122 has a nozzle plate 129 made of stainless steel, an elastic substrate 131 facing the nozzle plate 129, and a plurality of partition members 132 which bonds these plates to each other. A plurality of pressure generation chambers 133 and a plurality of liquid storage grooves 134 are formed by the partition members 132 between the nozzle plate 129 and the elastic substrate 131. The plurality of pressure generation chambers 133 and the plurality of liquid storage grooves 134 mutually communicate with each other via liquid flow entrances 138. The elastic substrate 131 is provided with a liquid supply hole 136 at a proper place, and the liquid supply hole 136 leads to the liquid storage portion 137. Therefore, the liquid storage portion 137 supplies a liquefied thing M to be ejected to the liquid supply hole 136. The supplied liquefied thing M fills up the liquid storage grooves 134, then also fills the pressure generation chambers 133 through the liquid flow entrances 138. In this way, the liquid storage portion 137 and the pressure generation chambers 133 communicate with another.

The nozzle plate 129 is provided with the nozzle orifices 127 for ejecting the liquefied thing M as liquid drops M0 from the pressure generation chambers 133, and the nozzle orifices 127 also communicate with the pressure generation chambers 133. In the elastic substrate 131, pressure generation elements 139 are mounted on the opposite surface of a surface on which the pressure generation chambers 133 are formed. For example, as shown in FIG. 6B, each of the pressure generation elements 139 is a deflection vibration mode piezo-electric element 141 including a piezo-electric element and a pair of electrodes 142a and 142b which pinch the piezo-electric element 141 therebetween. Arrow C shows the vibration direction. In addition, as shown in FIG. 6C, the pressure generation element 139 may be a longitudinal vibration mode piezo-electric element. In the longitudinal vibration mode piezo-electric element (pressure generation element 139), a piezo-electric material and an electric conduction material are alternately laminated by turns in parallel with the extension direction and one end thereof is fixed to the elastic substrate 131, and the other end is fixed to a base member 120. With such a pressure generation element 139, it contracts in the direction perpendicular to the lamination direction of electric conduction layers in the charged state, but contracts in the direction perpendicular to the electric conductive layers in the discharged state.

Whichever kind of the piezo-electric elements is used, it is deformed by a drive signal applied to the electrodes, which leads to contraction and expansion of the pressure generation chambers 133. In addition, a liquid repellent agent layer 143 made of Ni-tetra fluoroethylene eutectic plated layer is provided around the nozzle orifices 127 in order to prevent the flight bend of liquid drops M0 and the clogging of the nozzle orifices 127.

The liquid ejection head 122 which is constituted in such a way described above selectively ejects the liquefied thing M through the plurality of nozzle orifices while the undersurface thereof faces and moves along the surface of the first transparent substrate 21, so that the liquid drops M0 (liquid drops of the color filter material 29(R)) have come to reach the predetermined positions (formation positions of the first concave portions 21a). The other color filter materials 29(G) and 29(B) are ejected in the same way described above.

Next, as shown in FIG. 5G, in a solidification process, the color filter materials 29(R), 29(G), and 29(B) filled up in the first concave portions 21a are solidified by heat treatment, ultraviolet-rays irradiation, etc., and thus the color filters 22(R), 22(G), and 22(B) are formed.

Next, in a transparent protective layer formation process, as shown in FIG. 5H, the second transparent substrate 24 (a cover glass/a transparent protective layer) is bonded to the surface of the first transparent substrate 21, the surface having the color filters 22(R), 22(G), and 22(B) thereon, by an adhesive layer 23, such as epoxy-based or acryl-based adhesive layer, and then the adhesive layer 23 is solidified. As a result, the color filers 22(R), 22(G), and 22(B) will be in the state in which they are covered with the transparent protective layer made of the second transparent substrate 24.

Next, as shown in FIG. 5i, the second transparent substrate 24 undergoes a thinning process through which the second transparent substrate 24 becomes a thin plate. For example, the second transparent substrate 24 undergoes a polishing process and thus the thickness of the second transparent substrate 24 becomes 0.02 to 5 mm, and more preferably becomes 0.5 to 2 mm. Such a polishing method is performed by using abrasives (grains), such as cerium oxide and colloidal silica.

Next, a second concave portion formation process will be described. First, a mask layer (not shown) is formed on the surface of the second transparent substrate 24 and the second transparent substrate 24 undergoes an etching process. As a result, as shown in FIG. 5j, the second concave portions 24a having a rectangular shape are formed at the boundaries of the adjacent first concave portions 21a (the adjacent color filters 22(R), 22(G), and 22(B)). Finally, the mask layer is removed. In such a process, the mask layer is made of Au/Cr, Au/Ti, Pt/Cr, Pt/Ti, silicone (polycrystalline silicon, amorphous silicon), or silicon nitride film. The etching process performed with respect to the second transparent substrate 24 may be a wet etching method using the solution containing polyhydric alcohol and fluoric acid, such as glycerin and ethylene glycol, or a dry etching method.

Next, in a light shielding layer formation process, as shown in FIG. 5K, a light shielding film, such as molybdenum (Mo), tungsten (W), titanium (Ti), titanium nitride (TiN), and chromium (Cr) film is formed on the entire surface of the second transparent substrate 24, and then the light shielding layer is patterned by a photolithography technique. As a result, the light shielding layer 25a is formed so as to cover the second concave portions 24a. At this time, the light shielding layer 25b shown in FIGS. 1A and 1B is also simultaneously formed with the light shielding layer 25a. Thus, the micro-lens substrate 20a with a color filter is formed.

After that, as shown in FIGS. 4A and 4B, the transparent insulation film 28, the common electrode 26, and the aligning film 27 are formed on the light shielding layer 25a in turns, and thus obtain the opposing substrate 20.

### Advantageous Effects of Embodiments

As explained above, the micro-lens substrate 20a with a color filter of this embodiment includes the first transparent substrate 21, the first concave portions 21a formed on the first transparent substrate 21 and having a lens form, and the color filters 21(R), 21(G), and 21(B) formed by filling up the first concave portions 21a with the transparent color filter materials 29(R), 29(G), and 29(B). Here, the color filters 21(R), 21(G), and 21(B) also function as the micro-lenses. In other words, the micro-lenses themselves function as the color filters 21(R), 21(G), and 21(B). For this reason, even when adding the color filters 21(R), 21(G), and 21(B) to the micro-lens substrate 20a, there is almost no increase of cost. Moreover, since the micro-lenses themselves function as the color filters 21(R), 21(G), and 21(B), the relative accuracy of positions between the micro-lenses and the color filters 21(R), 21(G), and 21(B) does not cause a problem, it is possible to express a bright and high definition color display.

Moreover, since the light shielding layer 25a is formed at domains which overlap with the boundaries of the adjacent first concave portions 21a (boundaries of the adjacent color filters 22(R), 22(G), and 22(B)), it is possible to prevent the incidence of light at undesirable places, mixed colors, etc. In the surface of the second transparent substrate 24 that covers the color filters 22(R), 22(G), and 22(B) with this embodiment, since the second concave portions 24a are formed in the boundaries of the adjacent first concave portions 21a. Since the light-shielding layer 25a is formed inside the second concave portions 24, the color filters 22(R), 22(G), and 22(B), and the light shielding layer 25a are close to each other by the distance corresponding to the depth of the second concave portion 24. Accordingly, the light which has advanced in the inclined direction does not invade into the adjacent pixels, and thus it is possible to surely avoid the generation of mixed colors. That is, since the distance L2 between the light shielding layer 25a and each of the color filters 22(R), 22(G), and 2(B) is long in the reference example of FIG. 4C, the light which has advanced in the inclined direction indicated by an arrow P2 is not intercepted by the light shielding layer 25a, so that it invades into the adjacent pixels, resulting in the mixed color or the light interference. With this embodiment shown in FIG. 4B, since the distance L1 between the light shielding layer 25a and each of the color filters 22(R), 22(G), and 22(B) is relatively short, the light which has advanced in the inclined direction as shown by arrow P1 is intercepted by the light shielding layer 25a and thus does not invade into the adjacent pixels. As a result, the light does not invade into neighboring pixels and it is possible to prevent the mixed color from occurring. With this embodiment of the invention, which is sown in FIG. 4B, since the distance L1 between the light shielding layer 25a and the color filers 22(R), 22(G), and 22(B) is short, the light which has advanced in the inclined direction as indicated by arrow P3 is reflected from the side surface of the light shielding layer 25a and emitted from the corresponding pixel, the amount of display light is increased.

### Other Embodiments

With the above-described embodiment, although the micro-lens substrate 20a with a color filter is used as the opposing substrate 20, in the case in which light enters from the element substrate 10 side and display light is emitted from the opposing substrate 20 side, the micro-lens substrate 20a with a color filter may be used as the element substrate 10.

With the above-mentioned form, although the transparent protective layer was formed by the second transparent substrate 24, you may form a transparent protective layer with transparent resin etc.

With the above-described embodiment, although the micro-lens substrate 20a with a color filter is used for a liquid crystal device. Alternatively, the micro-lens substrate 20a may be used in an organic electroluminescence device (electro-optical device). In such a case, white light may be emitted from an organic EL device, and it may be emitted through a color filter. The micro-lens substrate 20a with a color filter of the invention may be applied to such organic electroluminescence device.

### Application to Electronic Apparatus

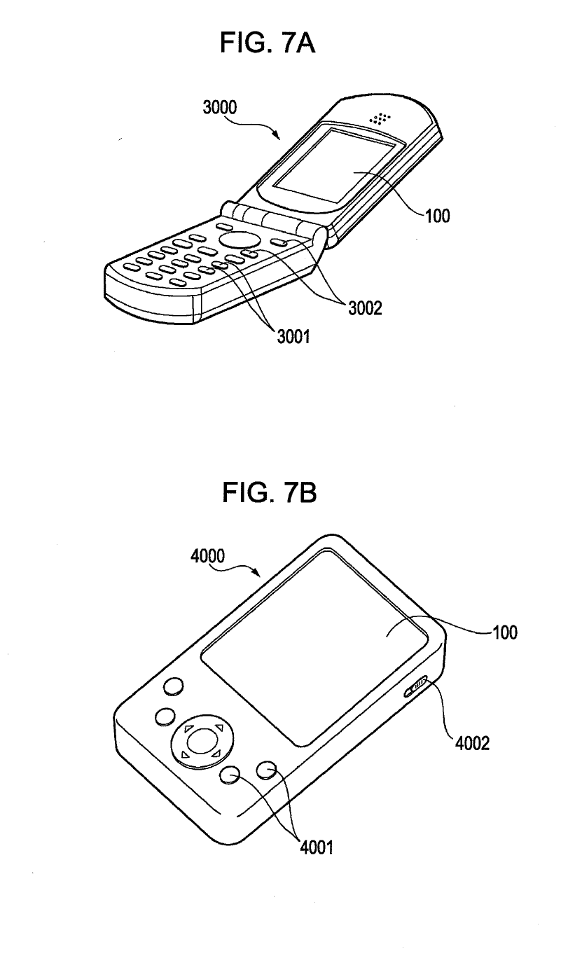

FIGS. 7A and 7B are explanatory views illustrating electronic apparatuses in which the electro-optical device to which the invention is applied is mounted. The electro-optical device to which the invention is applied is used as a direct-view type color display and a projection type liquid crystal display. For example, a cellular phone 3000 shown in FIG. 7A includes a plurality of operation buttons 3001, a scroll button 3002, and the electro-optical device 100 as a display unit (direct-view type color display device). By operating the scroll button 3002, the screen displayed on the electro-optical device 100 is scrolled. A personal digital assistants (PDA) shown in FIG. 7B includes a plurality of manual operation buttons 4001, a power switch 4002, and the electro-optical device 100 as a display unit (direct-view type color display). By operating the power switch 4002, various kinds of information, including addresses or schedules, will be displayed on the electro-optical device 100. Moreover, besides what are shown in FIGS. 7A and 7B, examples of the electronic apparatus to which the electro-optical device 100 is applied include a digital still camera, a liquid crystal television set, a view finder type or a monitor type videotape recorder, a car navigation system, a pager, an electronic notebook, a calculator, a word processor, the workstation, a video-conferencing phone, the POS terminal, and various kinds of apparatuses with a touch panel. The electro-optical device 100 mentioned above can be used as a display unit of these various electric apparatuses.

Furthermore, although illustration is omitted, if the electro-optical device 100 to which the invention is applied is used, a single plate-type projection display using only one sheet of a liquid crystal device 100 can be constituted. In this case, a projection display will have a light source unit which supplies light to the electro-optical device 100 and a projection optical system which carries out expansion projection of the light modulated by the electro-optical device 100 on an target surface to be projected, such as a screen.

The entire disclosure of Japanese Patent Application No. 2007-124210, filed May 9, 2007 is expressly incorporated by reference hereby.

What is claimed is:

1. A micro-lens substrate with a color filter comprising:
a first transparent substrate including a surface with first concave portions which have a lens shape;
color filters in a plurality of colors having a refractive index different from that of the first transparent substrate, the color filters being filled in the first concave portions;
a transparent protective layer over the color filters, the transparent protective layer including a second concave portion at an area overlapping a border adjacent ones of the first concave portions; and
a light shielding layer in the second concave portion.

2. The micro-lens substrate with a color filter according to claim 1, wherein the transparent protective layer is a second transparent substrate bonded to the first transparent substrate to cover the color filter material.

3. The micro-lens substrate with a color filter according to claim 1, wherein the color,filter material has a refractive index higher than that of the first transparent substrate.

4. An electro-optical device comprising the micro-lens substrate with a color filter according to claim 1.

5. The electro-optical device according to claim 4, wherein liquid crystals are held between the micro-lens substrate with a color filter and an opposing substrate arranged to face the micro-lens substrate with a color filter.

6. An electronic apparatus comprising the electro-optical device according to claim 4.

7. A method of manufacturing a micro-lens substrate with a color filter, comprising:
forming a base material by forming a first transparent substrate including a surface with first concave portions, each having a lens shape;
filling the first concave portions with a plurality of color filter material, which has a refractive index different from that of the first transparent substrate;
forming a transparent protective layer to cover the surface of the first transparent substrate, the surface having the color filter material thereon;
forming a second concave portion on a surface of the transparent protective layer at an area overlapping a border adjacent ones of the first concave portions; and
forming a light shielding layer in the second concave portions.

8. The method of manufacturing a micro-lens substrate with a color filter according to claim 7, wherein the filling the first concave portions is performed by ejecting the color filter material into the first concave portions from a liquid ejection head to fill the first concave portions.

9. The method of manufacturing a micro-lens substrate with a color filter according to claim 7, wherein the forming a light shielding layer is performed by bonding a second transparent substrate to the first transparent substrate to cover the color filter material, and forming the transparent protective layer by the second transparent substrate.
